(19) United States
(12) Patent Application Publication
(10) Pub. No.: US 2026/0324604 A1
(43) Pub. Date: Oct. 22, 2026

(54) VARROA MITE TRAP FOR BEEHIVES

(71) Applicant: Joseph Lawrence Rak, Avon, OH (US)

(72) Inventor: Joseph Lawrence Rak, Avon, OH (US)

(21) Appl. No.: 19/570,309

(22) Filed: Mar. 18, 2026

Related U.S. Application Data
(60) Provisional application No. 63/790,474, filed on Apr. 17, 2025.

(51) Int. Cl. A01K 51/00; A01K 47/06

(52) U.S. Cl. CPC A01K 51/00; A01K 47/06

(57) ABSTRACT

A Varroa mite trap configured to be removably positioned in a beehive. The trap includes a cover layer and a trap layer. The cover layer has a first surface and a second surface, wherein one or more openings are positioned on the cover layer, and the one or more openings are configured to permit passage of Varroa mites through the cover layer and to prevent passage of bees through the cover layer. The trap layer has a first surface and a second surface, wherein at least a portion of the first surface of the trap layer contains or is coated with an immobilizing agent. The first surface of the trap layer is positioned adjacent to the second surface of the cover layer to create a system to attract and capture Varroa mites.

### CROSS REFERENCE TO RELATED APPLICATION

This application claims priority from U.S. Provisional Patent Application Ser. No. 63/790,474, filed on Apr. 17, 2025, which application is incorporated herein by reference.

### TECHNICAL FIELD

The present disclosure relates to a Varroa mite trap for a beehive.

### BACKGROUND

The Varroa mite is an external parasitic mite that attacks and feeds on honey bees and is one of the most damaging honey bee pests in the world. Varroa mite infestation can lead to the death of an entire honey bee colony.

Parasitism of bees by mites in the genus Varroa is called varroosis. The Varroa mite can reproduce only in a honey bee colony. It attaches to the body of the bee and weakens the bee. The Varroa mite is a vector for at least five debilitating bee viruses, including RNA viruses such as the deformed wing virus (DWV). The Varroa mite is the parasite with possibly the most pronounced economic impact on the beekeeping industry and is one of multiple stress factors contributing to the higher levels of bee losses around the world. The Varroa mite has also been implicated as one of the causes of colony collapse disorder.

Miticides are difficult to time correctly while avoiding harm to the beehive. In addition, chemical miticides, whether synthetic or naturally produced, can negatively affect honey bee brood or queens. Varroa mite resistance to miticides is also a serious issue for beekeepers, with mites developing resistance to many common miticides.

As an external parasite, Varroa mites are prone to fall off bees and it is common to find Varroa mites on the bottom board of a beehive after infestation has occurred. Screened bottom boards have been used to trap mites which fall through the screen. While such bottom boards can aid in Varroa mite control, they also have disadvantages, including i) disrupting hive ventilation, ii) requiring closing the screen for certain treatments, iii) causing bees to work harder to stay warm in colder climates, and iv) becoming less effective or totally ineffective due to accumulation of falling hive debris. In addition, these bottom boards have limited effectiveness because they rely on mites passively falling off of bees and down onto the bottom board, which is only about 10-20%, and do not actively target mites.

There exists a continuing need for new and improved methods and traps for controlling Varroa mite populations in honey bee colonies.

### SUMMARY

According to one illustrative embodiment, disclosed is a Varroa mite trap configured to be removably positioned in a beehive, wherein the trap comprises i) a cover layer having a first surface and a second surface, wherein one or more openings are positioned on the cover layer, wherein the one or more openings are configured to permit passage of Varroa mites through the cover layer and to prevent passage of bees through the cover layer; and ii) a trap layer having a first surface and a second surface, wherein at least a portion of the first surface of the trap layer contains or is coated with an immobilizing agent, such as an adhesive, wherein the first surface of the trap layer is positioned adjacent to the second surface of the cover layer.

Also disclosed is a beehive brood box comprising a housing comprising four side walls and at least one Varroa mite trap configured to be removably positioned therein, wherein the trap comprises i) a cover layer having a first surface and a second surface, wherein one or more openings are positioned on the cover layer, wherein the one or more openings are configured to permit passage of Varroa mites through the cover layer and to prevent passage of bees through the cover layer; and ii) a trap layer having a first surface and a second surface, wherein at least a portion of the first surface of the trap layer contains or is coated with an immobilizing agent, such as an adhesive, wherein the first surface of the trap layer is positioned adjacent to the second surface of the cover layer.

Also disclosed is a beehive comprising (i) a top cover; (ii) a brood box; (iii) a honey super; (iv) a barrier layer configured to exclude a queen bee from the honey super (iii); and (v) a bottom board, wherein the brood box comprises a housing comprising four walls and at least one Varroa mite trap configured to be removably positioned therein, wherein the trap comprises i) a cover layer having a first surface and a second surface, wherein one or more openings are positioned on the cover layer, wherein the one or more openings are configured to permit passage of Varroa mites through the cover layer and to prevent passage of bees through the cover layer; and ii) a trap layer having a first surface and a second surface, wherein at least a portion of the first surface of the trap layer contains or is coated with an immobilizing agent, such as an adhesive, wherein the first surface of the trap layer is positioned adjacent to the second surface of the cover layer.

### BRIEF DESCRIPTION OF THE DRAWINGS

FIG. 1 is a front side exploded view of an illustrative Varroa mite trap.

FIG. 2 is a side view of the Varroa mite trap of FIG. 1.

FIG. 3 is a front perspective view of an illustrative Varroa mite trap.

FIG. 4 is a rear perspective view of an illustrative Varroa mite trap.

FIG. 5 is a front perspective view of an illustrative Varroa mite trap positioned within a hanging frame of a beehive.

FIG. 6 is an exploded perspective view of a bee hive comprising a top cover; a honey super; a barrier layer configured to exclude a queen bee from the honey super, a brood box containing an illustrative Varroa mite trap; and a bottom board.

### DETAILED DESCRIPTION

According to certain embodiments, disclosed is a Varroa mite trap configured to be removably positioned in a beehive. The trap comprises i) a cover layer having a first surface and a second surface, wherein one or more openings are positioned on the cover layer, wherein the one or more openings are configured to permit passage of Varroa mites through the cover layer and to prevent passage of bees through the cover layer, and ii) a trap layer having a first surface and a second surface, wherein at least a portion of the first surface of the trap layer contains or coated with an immobilizing agent, such as an adhesive, wherein the first surface of the trap layer is positioned adjacent to the second surface of the cover layer. The phrase immobilizing agent as used herein, refers to any material that reduces or eliminates movement or motion of a Varroa mite. The immobilizing agent may comprise an adhesive and/or a viscous material.

The Varroa mite described herein may include, for example, and without limitation, the following species: V. destructor, V. jacobsoni, V. rindereri, and V. underwoodi. In certain embodiments, the Varroa mite species is V. destructor.

In certain embodiments, at least a portion of the first surface of the cover layer mimics the appearance of at least one natural capped brood cell. In beekeeping, “capped brood” refers to bee larvae cells that have been sealed over with a wax cap as they enter the pupa stage of development, indicating the final stage of development before adult bees emerge from the capped brood cell. Capped brood cells appear darker than uncapped cells, and the caps are typically cream, light brown to brown, or tan, whereas uncapped brood cells are typically light yellow or white. In certain embodiments, the brood cells have a hexagonal or substantially hexagonal shape. Varroa mites reproduce within the capped brood cells of honeybees. The disclosed trap does not rely on mites passively falling from bees, but rather actively attracts and traps mites within an environment that mimics their reproductive environment. Varroa mites have a higher reproductive success in drone brood than in worker brood, as drone brood takes longer to develop. In certain embodiments, at least a portion of the first surface of the cover layer mimics the appearance of at least one natural capped drone brood cell. At least a portion of the first surface of the cover layer functions as an artificial capped brood with selective mite attraction and trapping mechanism. The term “artificial” as used herein, refers to a non-naturally occurring material, i.e., the term refers to material produced by a human. The term “natural” as used herein, refers to naturally occurring material.

According to embodiments wherein at least a portion of the first surface of the cover layer mimics the appearance of at least one natural capped brood cell, the primary purpose of the cover layer is to mimic capped brood cells to attract Varroa mites while preventing honey bee interference. The appearance of the capped brood cells on the cover layer visually and/or structurally resembles natural brood cells so that bees do not attempt to chew, fill, or remove the brood cells. In certain embodiments, the appearance of the capped brood cells replicates or substantially replicates the shape and/or appearance of natural capped drone brood to attract Varroa mites and to provide sufficient internal space therein to accommodate mite entry and trapping. In certain embodiments, the artificial capped brood cells substantially blend in visually and structurally with actual natural brood cells, helping it remain undisturbed and functional for an extended period of time.

In certain embodiments, the cover layer is composed of a wax-based material, a molded plastic material with or without wax coating, or combinations thereof. The cover layer may be constructed from material to balance realism, durability, compatibility with beehive conditions, and prevent chewing or removal by bees. By way of illustration, and not limitation, the cover layer may be composed of high-density polyethylene (HDPE) and/or polypropylene (PP) plastic. Additional materials, such as cellulose fibers or other additives, may be incorporated to substantially replicate the fibrous texture of natural brood cappings.

In certain embodiments, at least a portion of the first surface of the cover layer further comprises natural capped brood wax, brood extract, or combinations thereof. Natural capped brood wax are the wax lids of the sealed brood cells. Brood extract may include at least one natural honey bee egg, larvae or pupae, or components therefrom. In certain embodiments, at least a portion of the first surface of the cover layer comprises a wax coating. In certain embodiments, at least a portion of the wax coating comprises natural capped brood wax and/or brood extract to enhance attractiveness to Varroa mites.

In certain embodiments, the one or more openings in the cover layer have a diameter in the range of from about 200 microns to about 400 microns. In certain embodiments, the one or more openings are substantially circular, oblong, eye-shaped, elongated slits, ellipses, or combinations thereof. The one or more openings may have different orientations and/or shapes that are configured to prevent bees from detecting the openings and sealing them shut or chewing on the cover layer.

The Varroa mite trap further comprises a trap layer. Once a Varroa mite enters through the one or more openings on the cover layer, which do not permit bees to pass through, the mite is drawn into the interior of the trap. There, the mite encounters an immobilizing agent and/or substrate, such as an adhesive which immobilizes the mite upon contact. In certain embodiments, the immobilizing agent, such as an adhesive or viscous material, is applied directly to at least a portion of the first surface of the trap layer, which acts as the physical base of the Varroa mite trap. In certain embodiments, the trap layer comprises a biodegradable and/or synthetic substrate infused with at least one attractant to lure Varroa mites into the one or more openings on the cover layer. In certain embodiments, the at least one attractant comprise honey bee brood pheromones.

In certain embodiments, the immobilizing agent comprises a non-drying adhesive that maintains effectiveness over extended hive placements. In certain embodiments, the second surface of the trap layer does not contain an immobilizing agent. In certain embodiments, the first and/or second surface of the cover layer does not contain an immobilizing agent.

In certain embodiments, at least a portion of the trap layer is a transparent sheet. In certain embodiments, the entire trap layer comprises a transparent sheet. For example, the trap layer may comprise a clear plastic film, such as a clear transparent overhead projector film, sheet, laminate, panel, membrane, ply, or the like. The transparent portion of the trap layer or the transparent sheet permits visual monitoring of Varroa mite accumulation on the first surface of the trap layer without having to remove the cover layer. In certain embodiments, the immobilizing agent is applied to at least a portion of the first surface of the transparent trap layer, and the transparent trap layer is configured to permit a user to visibly count mite accumulation from the opposite, second surface of the trap layer. This dual-purpose design enables the trap to function not only as a capture surface but also as a transparent inspection window permitting inspection and monitoring without disturbing hive components, allowing for accurate, non-destructive monitoring of Varroa mite populations.

In certain embodiments, at least a portion of the first surface of the trap layer contains a Varroa mite attractant. By way of example, but not in limitation, the attractant may comprise at least one of: methyl palmitate, ethyl palmitate, or other brood-associated volatiles or semiochemicals that simulate the olfactory signals of capped brood. The attractant may comprise any substance known to attract Varroa mites. In certain embodiments, at least a portion of the immobilizing agent on the trap layer further includes a Varroa mite attractant. In certain embodiments, at least a portion of the first surface, at least a portion of the wax coating on the first surface, and/or at least a portion of the second surface of the cover layer includes a Varroa mite attractant. In certain embodiments, Varroa mite attractant may be embedded in the immobilizing agent, the wax coating on at least a portion of the first surface of the cover layer, or both. Inside the Varroa mite trap, the trap layer may be infused with chemical cues that mimic those associated with brood, drawing Varroa mites toward and into the trap. The attractants can be incorporated into the immobilizing agent itself, applied to the wax coating on the first or second surface of the cover layer, or both. Additionally, natural capped brood wax or brood extracts may be used to further enhance the lure effect.

In certain embodiments, the Varroa mite trap is configured to be positioned or inserted within a hanging frame of a beehive, allowing for easy integration of the trap into current beekeeping systems. The Varroa mite trap is configured to be integrated with existing beehive systems in a simple and non-disruptive way. In certain embodiments, the Varroa mite trap is configured to be positioned or inserted within a beehive as a self-contained framed structure compatible with configurations, such as Langstroth hives. According to this embodiment, the trap further comprises a frame that at least partially surrounds the outer perimeter of the trap. The trap may comprise a self-contained frame assembly that replaces a standard hive frame entirely and functions as both the trap and structural frame. This configuration is compatible with a variety of hive types that accept removable frames, including but not limited to Langstroth, Top Bar, or Warre hives.

In certain embodiments, the Varroa mite trap is a modular insert that can be positioned within an existing hanging frame that is then inserted into a beehive. This flexibility allows for seamless adoption by beekeepers using a variety of hive formats. The Varroa mite trap may be positioned within any portion of a beehive. In certain embodiments, the Varroa mite trap is positioned within a brood box, such as within a hanging frame within a brood box.

One or more Varroa mite traps may be positioned or inserted within a hanging frame of a beehive. In certain embodiments, two Varroa mite traps are positioned within a single hanging frame in a back-to-back configuration with the respective cover layers facing outwardly to maximize Varroa mite trapping on both sides of the hanging frame. This dual-facing trap configuration allows mites to approach from either side of a single hanging frame, effectively doubling the trapping surface within a compact footprint.

The Varroa mite trap is easily integrated into existing beehives and can easily be removed and replaced. In certain embodiments, the Varroa mite trap is positioned within a reusable frame as a modular insert, or alternatively, as part of a self-contained frame unit that is replaced in its entirety. This flexibility allows for straightforward maintenance and continued trap effectiveness over a long period of time.

In certain embodiments, the trap does not include any pesticides, such as insecticides or miticides. Certain pesticides can kill bees outright. Even at low doses, pesticides can have the following impacts on bees: impaired memory and learning; reduced foraging efficacy; disorientation, which also impairs foraging; a higher percentage of male offspring; reduced nesting activity; and increased susceptibility to disease and parasites. In addition, Varroa mites have developed resistance to pesticides used to control them. In certain embodiments, the disclosed Varroa mite trap provides for a pesticide-free, highly effective Varroa mite trapping solution that actively attracts and traps mites within an artificial brood environment, without harming honeybees, and which is adaptable for various hive types.

Also disclosed is a beehive brood box comprising a housing comprising four side walls and at least one of the disclosed Varroa mite traps removably positioned in the housing. In certain embodiments, the beehive brood box is a substantially rectangular or substantially square box with frames inside, where the queen lays eggs, and the bees raise their young (brood). The brood box may not include a top or bottom because it is part of a stacked system, where multiple boxes are placed one on top of the other. The brood box is configured to hold frames which are wooden or plastic rectangles with a wax or plastic foundation in the middle. The frames provide a structured space for bees to build their comb while allowing easy access for beekeepers to inspect the colony's health and progress. Frames help the beekeeper manage the space within the hive, ensuring the colony has enough room for brood rearing, honey storage, and pollen storage. In a standard Langstroth hive, the brood box typically holds 10 frames, providing sufficient space for a healthy colony. Beehive frames are suspended within the hive boxes to provide a structure for bees to build their comb. The method of hanging frames varies depending on the hive type and beekeeper preference. Frames are typically configured to slide into grooves within a hive box, allowing them to be easily inserted and removed. The grooves, located on the sides of the hive box, hold the frames in place.

Also disclosed is a beehive comprising (i) a top cover; (ii) a brood box; (iii) a honey super; (iv) a barrier layer configured to exclude a queen bee from the honey super (iii); and (v) a bottom board, wherein the brood box comprises a housing comprising four walls and at least one of the disclosed Varroa mite traps removably positioned in the housing.

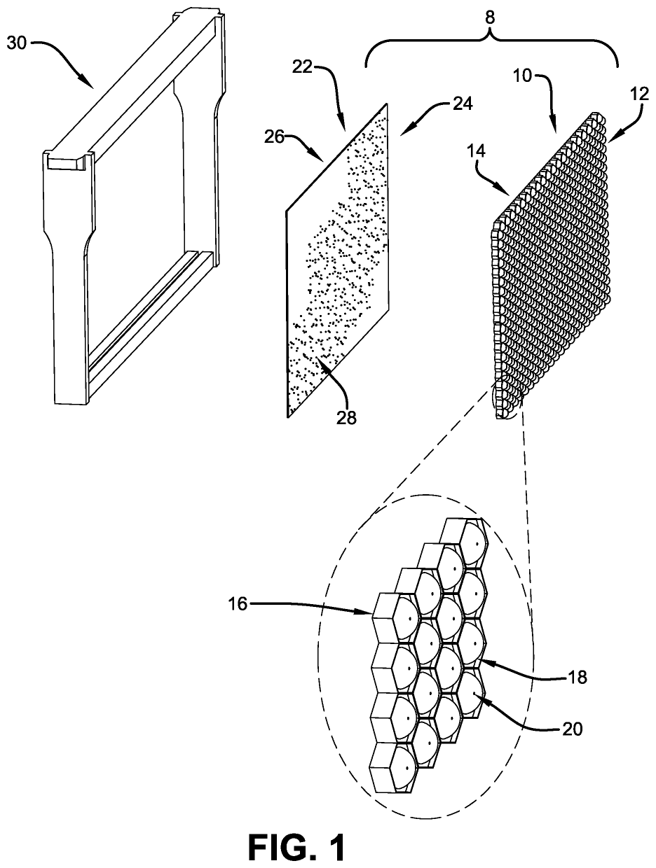

The disclosed Varroa mite trap is readily understood when read in conjunction with illustrative FIGS. 1-6. It should be noted that the Varroa mite trap is not limited to any of the illustrative embodiments shown in the figures, but rather should be construed in breadth and scope in accordance with the disclosure provided herein.

FIG. 1 is a side exploded view of an illustrative Varroa mite trap (8) configured to be removably positioned in a beehive (not shown). Trap (8) comprises cover layer (10) having first surface (12) and second surface (14). First surface (12) of cover layer (10) mimics the appearance of natural capped brood cells by having hexagonal cells (16) with cap (18). One or more openings (20) are positioned on each cap (18), and the one or more openings (20) are configured to permit passage of Varroa mites (not shown) through cover layer (10) and prevent passage of bees (not shown) through cover layer (10). Trap layer (22) has first surface (24) and second surface (26). At least a portion of first surface (24) of trap layer (22) includes adhesive immobilizing agent (28). The Varroa mite trap (8) is configured to be positioned or inserted within hanging frame such as a Langstroth frame (30) of a beehive (not shown), allowing for easy integration of trap (8) into current beekeeping systems.

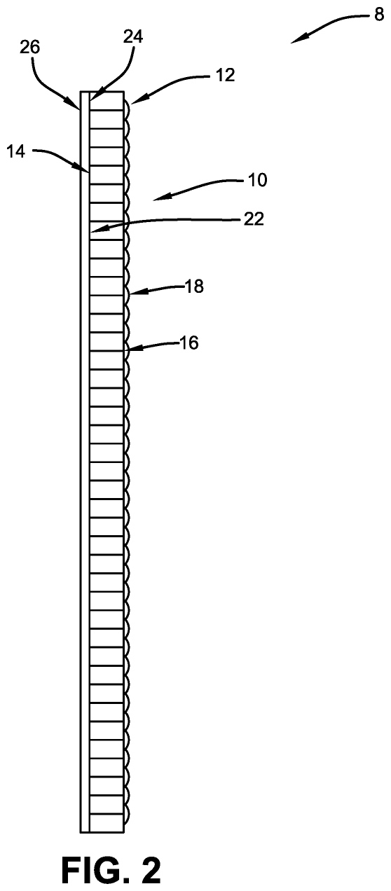

FIG. 2 is a side view of the Varroa mite trap (8) of FIG. 1. Trap (8) comprises cover layer (10) having first surface (12) and second surface (14). First surface (12) of cover layer (10) mimics the appearance of natural capped brood cells by having hexagonal cells (16) with cap (18). Trap layer (22) has first surface (24) and second surface (26). First surface (24) of trap layer (22) is positioned in abutting contact with second surface (14) of cover layer (10).

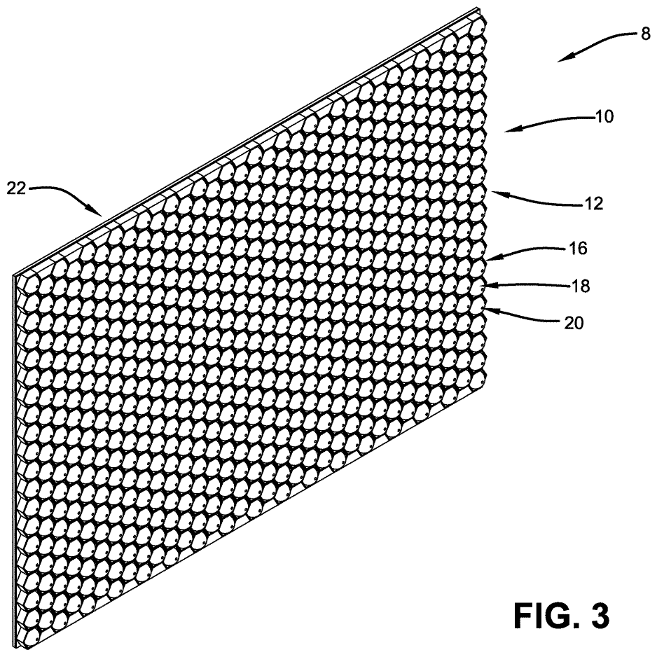

FIG. 3 is a front perspective view of the Varroa mite trap (8) of FIG. 1. Trap (8) comprises cover layer (10) having first surface (12) and second surface (not shown). First surface (12) of cover layer (12) mimics the appearance of natural capped brood cells by having hexagonal cells (16) with a cap (18), and the one or more openings (20) are positioned on each cap (18). The one or more openings (20) are configured to permit passage of Varroa mites through cover layer (10) and prevent passage of bees through cover layer (10). Trap layer (22) is in adjacent contact with the second surface (not shown) of cover layer (10).

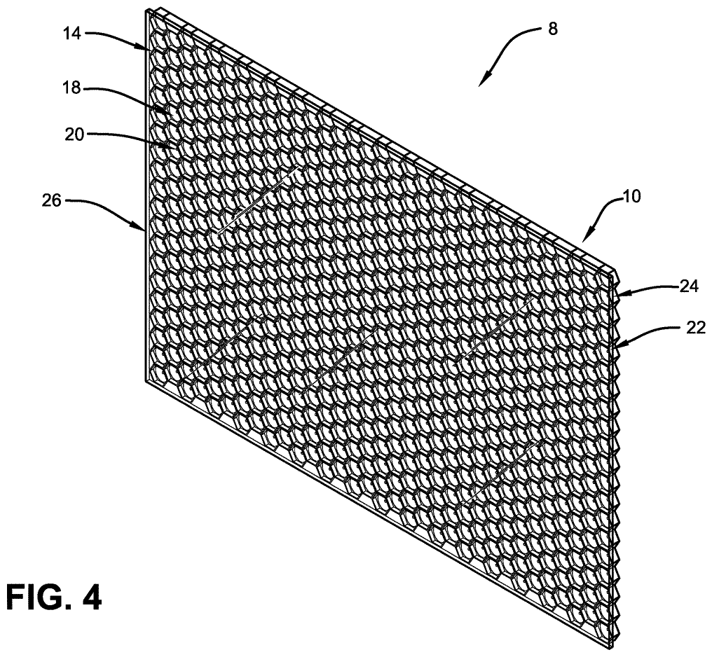

FIG. 4 is a rear perspective view of the Varroa mite trap (8) of FIG. 1. Trap (8) comprises cover layer (10) having first surface (not shown) and second surface (14). First surface (not shown) of cover layer (12) mimics the appearance of natural capped brood cells by having hexagonal cells (16) with a cap (18), and the one or more openings (20) are positioned on each cap (18). One or more openings (20) are configured to permit passage of Varroa mites through cover layer (10) and prevent passage of bees through cover layer (10). Transparent trap layer (22) has first surface (24) and second surface (26). Transparent trap layer (22) permits visual inspection within the hexagonal cells (16) and also permits monitoring of Varroa mite accumulation on first surface (24) of trap layer (22) without having to remove cover layer (10).

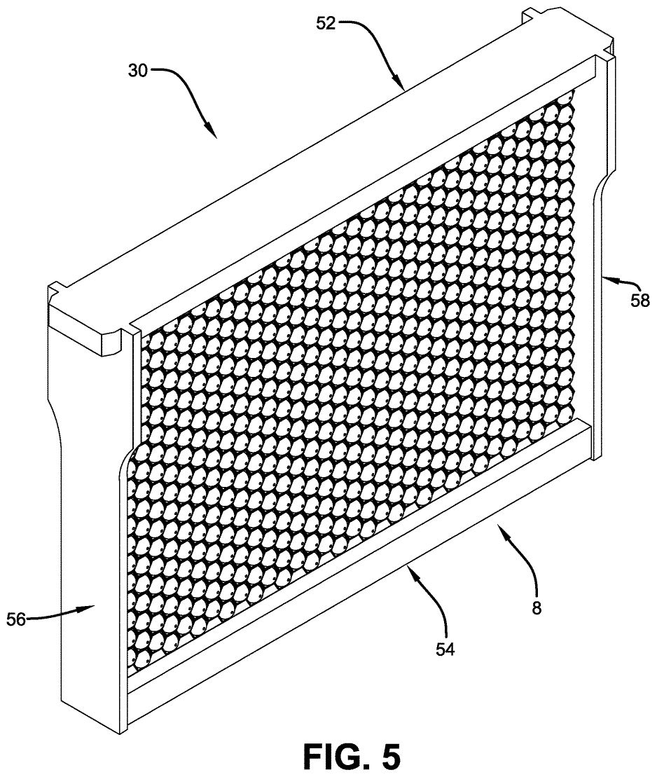

FIG. 5 is a front perspective view of the Varroa mite trap (8) of FIG. 1 positioned within a hanging frame (30) of a beehive (not shown). Frame (30) includes top frame section (52), bottom frame section (54), and side frame sections (56, 58).

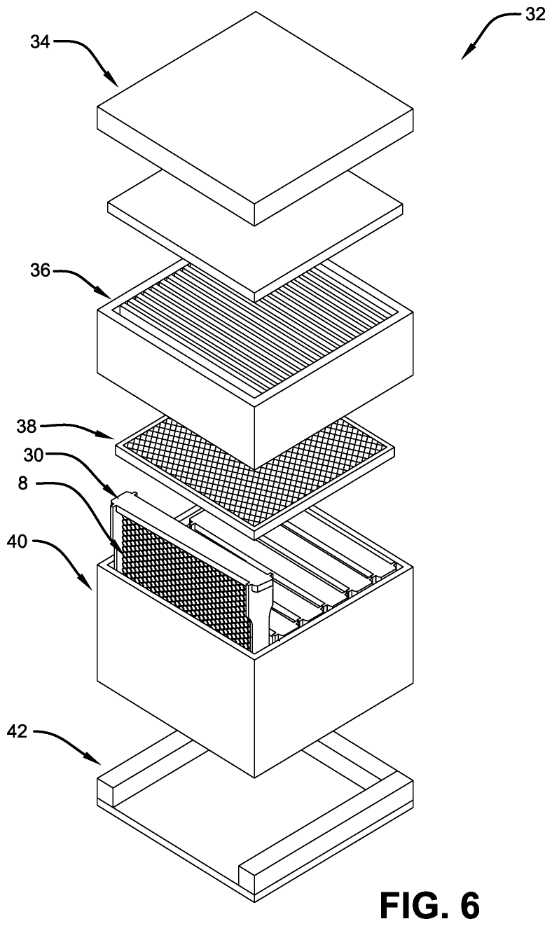

FIG. 6 is an exploded perspective view of a beehive (32) comprising top cover (34), honey super (36), barrier layer (38) configured to exclude a queen bee from honey super (36), brood box (40) containing the Varroa mite trap (8) of FIG. 1 positioned within hanging frame (30), and bottom board (42).

While the Varroa mite trap has been disclosed according to certain embodiments, it is to be understood that other similar embodiments may be used or modifications and additions may be made to the described embodiments for performing the same function. Furthermore, the various illustrative embodiments may be combined to produce the desired results. Therefore, the present disclosure should not be limited to any single embodiment.

As used in this specification, the terms “comprises,” “comprising,” “contains,” “containing,” “includes,” “including,” “has,” or “having,” are all open-ended expressions and are intended to cover apparatus, compositions, methods, processes, products, or systems that comprise a recited list of components, elements, and features, and any and all additional components, elements and features that are not expressly recited. The terms “includes,” “including,” “has,” or “having” are not intended to have a more narrow construction, interpretation, or meaning than the terms “comprises” or “comprising.”

In the present disclosure, the term “substantially” refers to a degree of deviation that is sufficiently small so as to not measurably detract from the identified property or function or circumstance and/or refer to slight variations within normal manufacturing tolerances.

As used in the present specification, the term “or” refers to an inclusive “or” and not to an exclusive “or”. For example, the phrase “A or B” is satisfied by any one of the following: A is present and B is not present, A is not present and B is present, and both A and B are present.

As used in the present specification, “a” or “an” is employed to describe components, elements, features and method/process steps of various illustrative embodiments disclosed herein. The use of “a” or “an” should be interpreted to include one or more than one.

As used in the present specification, any of the terms “illustratively,” “preferably,” “commonly,” and “typically” are not intended to, and do not, limit the scope of the claimed embodiments, or to imply that certain features are critical, essential, important, or required to the structure or function of the claimed composition, beverage product or methods. Rather, these terms are merely intended to identify particular aspects of an embodiment or to emphasize alternative or additional features that may or may not be utilized in a particular embodiment.

1. A Varroa mite trap configured to be removably positioned in a beehive, wherein the trap comprises i) a cover layer having a first surface and a second surface, wherein one or more openings are positioned on the cover layer, wherein the one or more openings are configured to permit passage of Varroa mites through the cover layer and to prevent passage of bees through the cover layer; and ii) a trap layer having a first surface and a second surface, wherein at least a portion of the first surface of the trap layer contains or is coated with an immobilizing agent, wherein the first surface of the trap layer is positioned adjacent to the second surface of the cover layer.

2. The trap of claim 1, wherein at least a portion of the first surface of the cover layer mimics the appearance of natural capped brood cell.

3. The trap of claim 1, wherein at least a portion of the first surface of the cover layer mimics the appearance of natural capped drone brood cell.

4. The trap of claim 1, wherein the cover layer is composed of a wax-based material, a molded plastic material with or without wax coating, or combinations thereof.

5. The trap of claim 1, wherein the one or more openings in the cover layer have a diameter in the range of from about 200 microns to about 400 microns.

6. The trap of claim 1, wherein the one or more openings are eye-shaped, elongated slits, ellipses, or combinations thereof.

7. The trap of claim 1, wherein at least a portion of the trap layer is transparent.

8. The trap of claim 7, wherein the transparent trap layer portion permits monitoring of Varroa mite accumulation on the first surface of the trap layer without having to remove the cover layer.

9. The trap of claim 1, wherein at least a portion of the first surface of the trap layer contains a Varroa mite attractant.

10. The trap of claim 9, wherein the attractant comprises at least one of methyl palmitate, ethyl palmitate, or other brood-associated volatiles or semiochemicals that simulate the olfactory signals of capped brood.

11. The trap of claim 1, wherein the immobilizing agent further includes a Varroa mite attractant.

12. The trap of claim 1, wherein at least a portion of the first surface and/or at least a portion of the second surface of the cover layer includes a Varroa mite attractant.

13. The trap of claim 1, wherein the second surface of the cover layer is in abutting contact with the first surface of the trap layer.

14. The trap of claim 1, wherein the second surface of the trap layer does not contain an immobilizing agent.

15. The trap of claim 1, wherein the trap is configured to be positioned within a hanging frame of a beehive.

16. The trap of claim 15, wherein the hanging frame is positioned in a brood box.

17. The trap of claim 1 further comprising a frame that at least partially surrounds the outer perimeter of the trap.

18. The trap of claim 1, wherein the trap does not include any pesticides.

19. A beehive brood box comprising a housing comprising four walls and at least one trap of claim 1 removably positioned in the housing.

20. A beehive comprising (i) a top cover; (ii) a brood box; (iii) a honey super; (iv) a barrier layer configured to exclude a queen bee from the honey super (iii); and (v) a bottom board, wherein the brood box comprises a housing comprising four walls and at least one trap of claim 1 removably positioned in the housing.
